(19) United States
(12) Patent Application Publication
(10) Pub. No.: US 2005/0086687 A1
(43) Pub. Date: Apr. 21, 2005

(54) Methods and systems for managing viewing of multiple live electronic presentations

(75) Inventor: Nosakhare D. Omoigui, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 10/969,302

(22) Filed: Oct. 20, 2004

Related U.S. Application Data
(63) Continuation of application No. 09/465,529, filed on Dec. 16, 1999.

(51) Int. Cl. H04N 5/445; G06F 3/00; H04N 7/10; H04N 7/025; H04H 9/00; H04N 7/16

(52) U.S. Cl. 725/35; 725/46; 725/34; 725/9; 725/14

(57) ABSTRACT

Viewing management systems for managing viewing of multiple live electronic presentations are described. In one described embodiment, viewers are given an opportunity to register their preferences for viewing certain events that can occur within a plurality of different electronic presentations. The selected electronic presentations are simultaneously monitored, during their broadcast, while a viewer might be watching only one of the electronic presentations. When one or more of the viewer-defined events is detected, the viewer is notified that the event is taking place.

### RELATED APPLICATION

This is a continuation of and claims priority to U.S. patent application Ser. No. 09/465,529, filed on Dec. 16, 1999, the disclosure of which is incorporated by reference herein.

### TECHNICAL FIELD

The present invention relates to interactive entertainment systems, such as interactive television or interactive computing network systems. In particular, the invention relates to methods and systems for managing viewing of multiple live electronic presentations.

### BACKGROUND

Television viewers are very aware of the number of programs that are offered for viewing at any one particular time. Today, especially with the continued advancements in cable and satellite broadcasting, viewers have a seemingly endless selection of shows from which to choose. Not surprisingly, there is often more than one show that a viewer may be interested in viewing. Yet, viewers are very limited in the number of shows that they can view.

In the past, when more than one program of interest was broadcast, a viewer could effectively view portions of both programs by simply changing the channel back and forth between the programs. This approach is not ideal for a couple of reasons. First, a viewer must be diligent in switching between the programs. This is particularly true when there are only specific events in the programs that the viewer is interested in viewing. For example, suppose that there is a golf tournament and a football game being broadcast on different channels and that a viewer is interested in viewing aspects of each broadcast. With respect to the gold tournament, the viewer might only wish to view Tiger Woods and John Daly teeing off, Tiger Woods and John Daly on the 18^{th} hole, and all putts and approach shots from Mark Duval. With respect to the football game, the viewer might be particularly interested in third and fourth down plays, and the last two minutes of the first and second halves. In order to view all of these desired events, the viewer will have to switch back and forth fairly frequently to ensure that they do not miss any of the events. Second, a viewer may switch channels many times just to check the status of the programs even when an event of interest is not being broadcast. This can detract from the viewer's viewing experience of the programs.

One attempt to solve problems associated with viewing multiple live program broadcasts has been the picture-in-picture (PIP) technology. Using this technology, a viewer will typically have a main program that occupies the viewing screen, with a smaller portion of the viewing screen being dedicated to another program. Hence, a viewer is able to view two programs simultaneously. This solution is not optimal for the following reasons. A viewer may not necessarily wish to view the entire broadcast of a particular program. Yet, the PIP approach forces them to do so. For example, suppose that the viewer from the above example is interested in watching the entire football game, but is only interested in the mentioned golfing events. Using the PIP approach, the viewer would be forced to view the golfing event in the smaller viewing screen to be assured that they do not miss any of the desired events. Not only is this wasteful (from the standpoint of having to view portions of a program that are otherwise undesirable), but it also diminishes the viewer's viewing experience with respect to the football game. This is because a portion of the field of view of the game is occupied by the PIP screen.

Perhaps another approach to viewing multiple live programs that bears mentioning is one in which one program is recorded (such as on a VCR) while another program is viewed by the viewer. This approach falls short of the mark for a number of reasons. First, the viewer is required to watch both shows at different times. This means that the viewer must spend up to twice the amount of time to view just two shows than the time during which the two shows were broadcast. If there are more than two shows, the time requirement (and the hardware requirement, i.e. the number of VCRs required) increases. Second, to get to the events of interest in the recorded program, the viewer must advance through the entire program. This is wasteful because the viewer must view portions of the broadcast in which they might not necessarily be interested.

Needless to say, up to now, the approaches that have been taken to give viewers a good viewing experience when attempting to view multiple live electronic broadcasts has been less than satisfactory. Accordingly, this invention arose out of concerns associated with providing an improved viewing experience when attempting to view multiple live broadcasts. Such broadcasts do not necessarily have to be television broadcasts, as will become apparent below.

### SUMMARY

Viewing management systems for managing viewing of multiple live electronic presentations are described. In one described embodiment, viewers are given an opportunity to register their preferences for viewing certain events that can occur within a plurality of different electronic presentations. The selected electronic presentations are simultaneously monitored, during their broadcast, while a viewer might be watching only one of the electronic presentations. When one or more of the viewer-defined events is detected, the viewer is notified that the event is taking place.

Various notifications can be given. In one aspect, notification takes place by automatically switching from one presentation to the other. In this manner, a viewer does not need to become involved in the switching process. In another aspect, a visual or audible notification can be given, e.g. a small icon might pop up on the viewer's screen. The viewer can then choose to switch to the other presentation. In yet another aspect, the electronic presentation that corresponds to the detected event can be displayed for the viewer as a picture-in-picture (PIP). The viewer can then choose to enlarge the PIP as appropriate.

Another aspect of the invention gives the viewer an opportunity to assign priorities to various events for which they can register. The priorities can then be used to determine how to generate notifications. For example, if the viewer is viewing a high priority presentation, then when an event triggers in a lower priority presentation, rather than automatically switching to the lower priority presentation, a simple visual notification might be displayed for the viewer. Conversely, if the viewer is viewing a lower priority presentation and a higher priority event triggers, then the viewer might be automatically switched to the higher priority presentation.

In another embodiment, the viewer need not register at all for events. The viewer's viewing habits are monitored to determine particular events within particular electronic presentations that the viewer is likely to want to view. From the monitored viewing habits, a correlation is established between the time that a viewer views a particular electronic presentation and the events that transpire during that time. Based on the correlation, viewers are notified when events occur that the viewers might likely wish to view.

### BRIEF DESCRIPTION OF THE DRAWINGS

FIG. 1 is a diagram that illustrates a network system and environment in accordance with one embodiment of the invention.

FIG. 2 is a diagram that illustrates a network system and environment in accordance with one embodiment of the invention.

FIG. 3 shows a general example of a computer that can be used in implementation of one or more embodiments of the invention.

FIG. 4 is a block diagram of an exemplary encoder/server, source and database in more detail.

FIG. 5 is a diagram of an exemplary viewer information database in more detail.

FIG. 6 is a diagram of an exemplary live content database in more detail.

FIG. 7 is a block diagram of an exemplary user interface in accordance with one embodiment of the invention.

FIG. 8 is a diagram of a display that can be rendered on a client processing device using the user interface of FIG. 7.

FIG. 9 is a diagram of a display that can be rendered on a client processing device using the user interface of FIG. 7. The FIG. 9 display can be selected from and is one level below the FIG. 8 display.

FIG. 10 is a diagram of a display that can be rendered on a client processing device using the user interface of FIG. 7. The FIG. 10 display can be selected from and is one level below the FIG. 8 display.

FIG. 11 is a flow diagram that describes steps in a method in accordance with one embodiment of the invention.

FIG. 12 is a flow diagram that describes steps in a method in accordance with one embodiment of the invention.

FIG. 13-15 are diagrams that show aspects of how viewer correlations are calculated in accordance with one embodiment.

### DETAILED DESCRIPTION

Exemplary Network Structure

Principles of the invention described below can be implemented in connection with any suitable network that can enable electronic presentations to be broadcast and received. Examples of electronic presentations include, without limitation, multimedia presentations such as steaming multimedia presentations and television programs, to name just a few. It is to be appreciated that the described embodiment constitutes but a few examples, and is not intended to limit the invention to the specifically illustrated architecture.

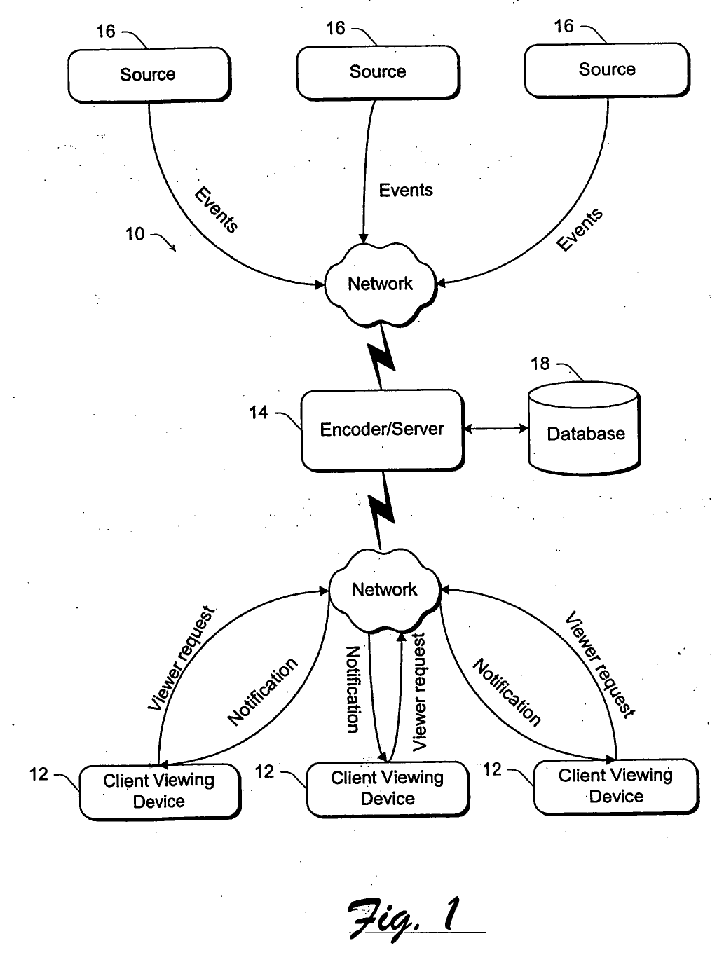

FIG. 1 shows a network system 10 in the form of a client/server system in accordance with one embodiment of the invention. Generally, system 10 includes one or more client viewing devices 12 that are used by viewers, one or more encoders/servers 14, and one or more sources 16 of the electronic presentations. The client viewing devices 12, server 14, and sources 16 communicate with each other over a data communications network.

System 10 includes one or more sources 16 that, in this example, supply electronic presentations in the form of continuous video content programs. The programs are provided to multiple subscribers or viewers by way of the client viewing devices 12. Programs provided by sources 16 might include traditional broadcast TV shows or streaming multimedia presentations.

The sources 16 supply video and other data over a distribution network to the subscribers. The network can comprise any suitable network in which distribution can take place. For example, the network can comprise a satellite network which transmits the data in a digital format from the sources. A typical satellite network includes a transmitter, an orbiting satellite, and a receiver. As one example, the satellite network can be implemented using DSS (Direct Satellite System) technology, where individual subscribers own small receiving dishes which are resident at their homes. Video, audio, and other data are transmitted in digital format from the satellite transmitter to the orbiting satellite, where the data are redirected to the satellite receiver.

The distribution network can be implemented in other ways instead of DSS technology. One implementation is a multi-tier network which includes a high-speed, high-bandwidth fiber optic cable network between the sources 16 and regional distribution nodes (not shown), and conventional home entry lines, such as twisted-pair lines or coaxial cable, between the distribution nodes and client viewing devices 12. Another network implementation might include traditional RF broadcast technologies. The network can also be constructed using a combination of wireless and wire-based technologies.

Another approach to broadcasting the electronic presentations to the subscribers is by multicasting the content over the Internet. With this approach, the sources 16 transmit the data content to a designated multicast address on the Internet. Subscribers listen to the multicast address to receive the primary content.

Each subscriber or viewer has at least one client viewing device 12. The client viewing device 12 can be a television or a broadcast-enabled personal computer, or simply “broadcast PC.” Other client viewing devices with processing components therein are possible. For example, the client viewing device 12 can be implemented as a set-top box coupled to a conventional television.

Sources 16 are configured to originate the electronic presentations or broadcast programs, or to rebroadcast programs received from another source, such as a satellite feed or another cable system. Sources 16 can include a continuous media server which distributes digital video data streams kept in a programs database. The continuous media server and video program database can be implemented, for example, as a disk array data storage system consisting of many large capacity storage disks.

Client viewing devices 12 are configured to display the electronic presentations for one or more viewers. The client viewing devices might receive the presentation broadcasts outside of the network that is shown in FIG. 1. As indicated above, there are times when viewers might desire to view more than one presentation at a time. For example, there may be a football game available from one source and a golf tournament available from another source.

In accordance with one embodiment, each viewer is given an opportunity to register with encoder/server 14 for notifications concerning multiple live electronic broadcasts. Registration takes place in the form of a viewer request that is formulated by the viewer and passed on to the encoder/server. In the described embodiment, each client viewing device 12 is interactive in the sense that it allows a viewer to enter information which is then passed on to the encoder/server 14. Examples of user interfaces that allow a viewer to do this are given below. Once the viewer requests are received by the encoder/server 14, it creates entries in a database 18 that it manages. Each of the entries corresponds to a particular viewer's choices. In the context of this document, these viewer choices are termed “viewer-defined preferences” or simply “preferences”. As the sources 16 broadcast their particular presentations, events are triggered and sent by the sources to the encoder/server 14. These triggered events describe some current aspect of the electronic presentation. For example, if Tiger Woods is getting ready to tee off on the 16^{th} hole, the event that might be triggered by the source and sent to the encoder/server 14 might be “Woods tee off on 16^{th}”. Once the encoder/server receives the triggered event, it conducts a search of the database 18 to identify all of the viewers that have registered for notification. Once the viewers are identified, individual notifications are sent from the encoder/server 14 to the client viewing devices 12.

In this embodiment, the encoder/server 14 receives both the viewer requests from the viewers and the events from the sources 16. The encoder/server 14 then undertakes to determine which notifications have to be sent and where they are to be sent.

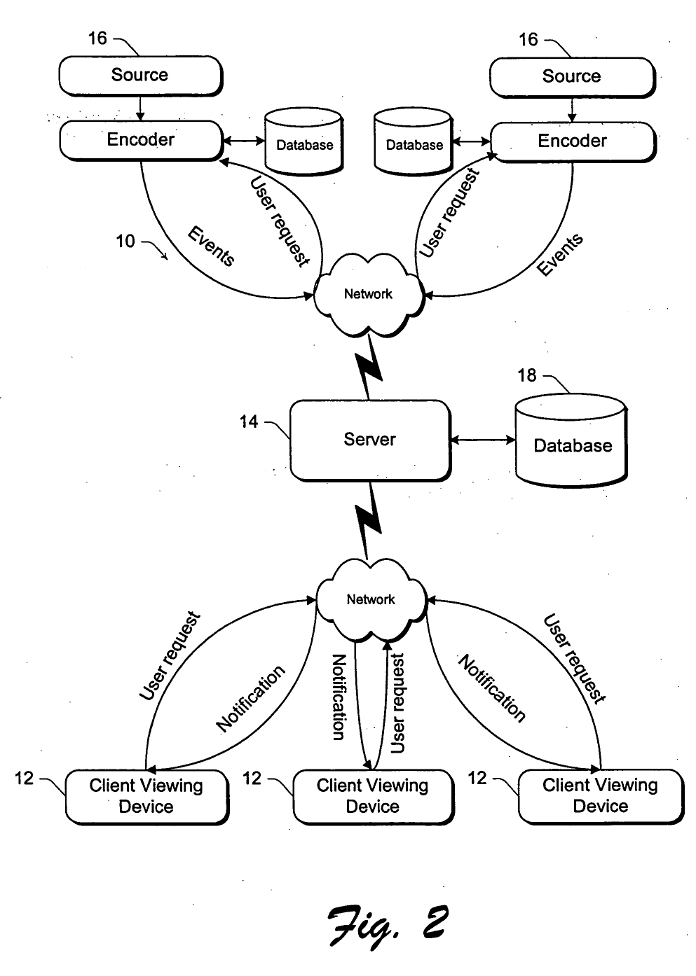

FIG. 2 illustrates another possible configuration in which the encoders are separate from the server 14. Here, the viewer requests are initially sent to the server 14. The server 14 establishes data records for the viewers in the database 18. The data records enable the server to know where to send notifications. The viewer requests are then sent on from the server 14 to one or more encoders. The encoders have their own databases that are used to maintain the information contained in the viewer requests, i.e. which events are to be the subject of notification. The encoders monitor the broadcast of each of their associated sources. When an event is detected for which notification has been registered, the encoders send the event to server 14 along with an identification of which viewers have requested notification. The server 14 then determines where the notifications are to be sent and sends them to the appropriate client viewing devices 12.

In the described example, two or more concurrently-broadcast electronic presentations are simultaneously monitored. Notifications are generated based upon viewer-defined preferences. The viewer-defined preferences can include any suitable preferences. For example, a viewer can set a preference based upon the title of a particular program (e.g. “notify me when Program X is being broadcast”), various topics that can occur within a particular broadcast (e.g. “notify me when the topic of computer software is discussed on Wall Street Week”), or various events that can occur within a program (e.g. “notify me when Tiger Woods is on the tee), to name just a few. Thus, while a viewer is watching one program, other viewer-selected programs are automatically monitored without the viewer having to get involved in the monitoring process. When certain events are detected, notification is automatically sent to the viewer. Thus, the viewer is ensured that they can view a desired program and be notified only when those specifically desired events in other programs occur.

Notifications

In the described embodiment, notifications can be sent in a number of different ways. For example, a viewer can be notified by having their client viewing device automatically switched from one program to another. In this manner, a viewer need not become involved in the switching process. Alternately, a viewer can be notified by having a picture-in-picture (PIP) screen enabled on their client viewing device. In this manner, a viewer can view the program that is the subject of the notification and can opt to view it as a PIP presentation, maximize the screen for optimal viewing, or cancel the PIP screen to continue viewing the original program. Alternately, various indicia can be used to indicate to the viewer that an event of interest has been detected in another program. For example, a small icon can pop up in the viewer's display. A viewer can then opt to either switch to the program, view the program in a PIP display, or not view the program at all.

Priorities

One aspect of the invention allows viewers to prioritize the manner in which their notifications are to take place. For example, priorities can be set or assigned for different presentations or programs, or events or topics that occur within certain presentations or programs. Specific examples of the use of priorities is given below.

Exemplary Computer System

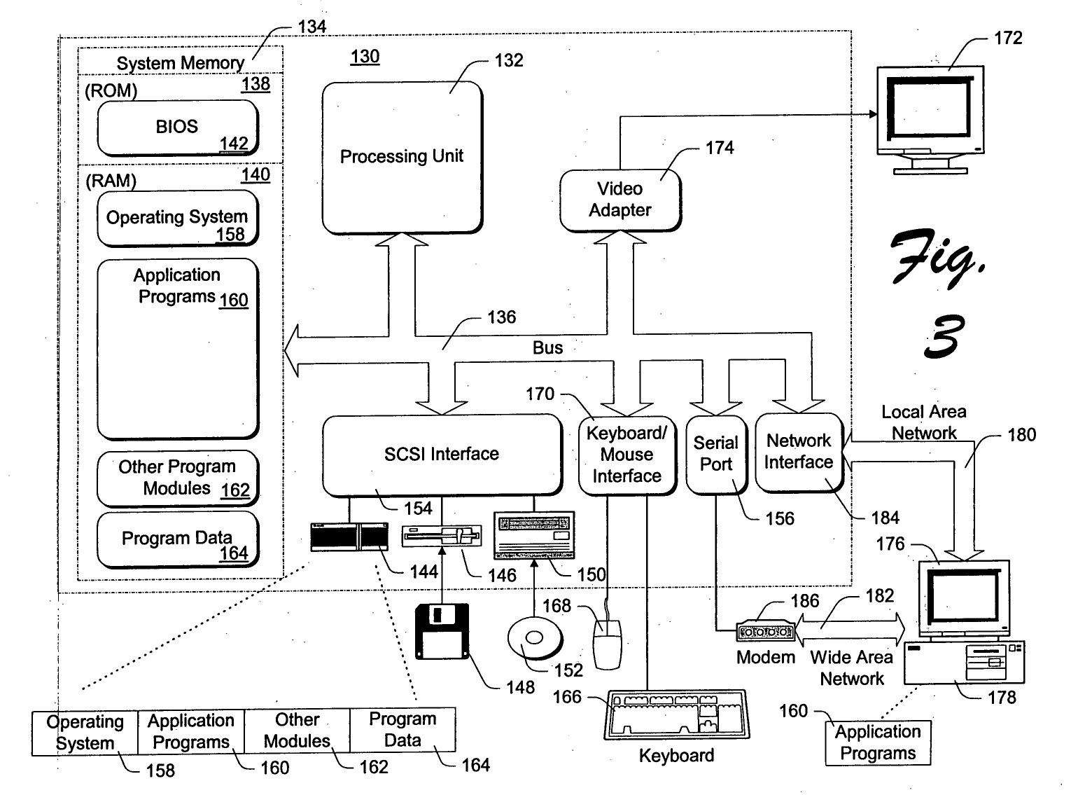

FIG. 3 shows a general example of a computer 130 that can be used in accordance with the invention. The computer, or aspects thereof, can be used to implement the encoder/server 14, the client viewing devices 12, or aspects thereof.

Computer 130 includes one or more processors or processing units 132, a system memory 134, and a bus 136 that couples various system components including the system memory 134 to processors 132. The bus 136 represents one or more of any of several types of bus structures, including a memory bus or memory controller, a peripheral bus, an accelerated graphics port, and a processor or local bus using any of a variety of bus architectures. The system memory 134 includes read only memory (ROM) 138 and random access memory (RAM) 140. A basic input/output system (BIOS) 142, containing the basic routines that help to transfer information between elements within computer 130, such as during start-up, is stored in ROM 138.

Computer 130 further includes a hard disk drive 144 for reading from and writing to a hard disk (not shown), a magnetic disk drive 146 for reading from and writing to a removable magnetic disk 148, and an optical disk drive 150 for reading from or writing to a removable optical disk 152 such as a CD ROM or other optical media. The hard disk drive 144, magnetic disk drive 146, and optical disk drive 150 are connected to the bus 136 by an SCSI interface 154 or some other appropriate interface. The drives and their associated computer-readable media provide nonvolatile storage of computer-readable instructions, data structures, program modules and other data for computer 130. Although the exemplary environment described herein employs a hard disk, a removable magnetic disk 148 and a removable optical disk 152, it should be appreciated by those skilled in the art that other types of computer-readable media which can store data that is accessible by a computer, such as magnetic cassettes, flash memory cards, digital video disks, random access memories (RAMs), read only memories (ROMs), and the like, may also be used in the exemplary operating environment.

A number of program modules may be stored on the hard disk 144, magnetic disk 148, optical disk 152, ROM 138, or RAM 140, including an operating system 158, one or more application programs 160, other program modules 162, and program data 164. A viewer may enter commands and information into computer 130 through input devices such as a keyboard 166 and a pointing device 168. Other input devices (not shown) may include a microphone, joystick, game pad, satellite dish, scanner, or the like. These and other input devices are connected to the processing unit 132 through an interface 170 that is coupled to the bus 136. A monitor 172 or other type of display device is also connected to the bus 136 via an interface, such as a video adapter 174. In addition to the monitor, personal computers typically include other peripheral output devices (not shown) such as speakers and printers.

Computer 130 commonly operates in a networked environment using logical connections to one or more remote computers, such as a remote computer 176. The remote computer 176 may be another personal computer, a server, a router, a network PC, a peer device or other common network node, and typically includes many or all of the elements described above relative to computer 130, although only a memory storage device 178 has been illustrated in FIG. 3. The logical connections depicted in FIG. 3 include a local area network (LAN) 180 and a wide area network (WAN) 182. Such networking environments are commonplace in offices, enterprise-wide computer networks, intranets, and the Internet.

When used in a LAN networking environment, computer 130 is connected to the local network 180 through a network interface or adapter 184. When used in a WAN networking environment, computer 130 typically includes a modem 186 or other means for establishing communications over the wide area network 182, such as the Internet. The modem 186, which may be internal or external, is connected to the bus 136 via a serial port interface 156. In a networked environment, program modules depicted relative to the personal computer 130, or portions thereof, may be stored in the remote memory storage device. It will be appreciated that the network connections shown are exemplary and other means of establishing a communications link between the computers may be used.

Generally, the data processors of computer 130 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. The invention described herein includes these and other various types of computer-readable storage media when such media contain instructions or programs for implementing the steps described below in conjunction with a microprocessor or other data processor. The invention also includes the computer itself when programmed according to the methods and techniques described below.

For purposes of illustration, programs and other executable program components such as the operating system are illustrated herein as discrete blocks, although it is recognized that such programs and components reside at various times in different storage components of the computer, and are executed by the data processor(s) of the computer.

Encoders and Notification Server

FIG. 4 shows an exemplary encoder/server 14, source 16, and database 18 in more detail in accordance with one embodiment. Server 14 includes one or more registration interfaces 20, an analysis/search engine 22 and a database controller 24 that controls and maintains database 18. Source 16 includes, in this example, an encoder 26.

It will be appreciated that encoder 26 can be a separate, non-integral component of the source. Encoder 26 receives live content or presentations which, in this example, comprises different media streams 17. Encoders 26 can be dedicated media servers, or alternatively other more general-purpose computer systems. These media streams 17 can be individual media streams (e.g., audio, video, graphical, etc.), or alternatively can be composite media streams including two or more of such individual streams. The media streams 17 can be provided to the encoders on a “live” basis from other data source components through dedicated communications channels or through the Internet itself. The encoder can also be a human being who is observing an electronic presentation or program and rendering live information about the presentation.

Encoders 26 coordinate the streaming of the live content to other components on the network that request the content or notifications thereof, such as client processing device 12. It is to be appreciated that although the media streams are referred to as being “live”, there may be a delay (e.g., between one second and thirty seconds) between the time of the actual event and the time the media streams reach the encoder(s).

There are various standards for streaming media content and composite media streams. “Advanced Streaming Format” (ASF) is an example of such a standard, including both accepted versions of the standard and proposed standards for future adoption. ASF specifies the way in which multimedia content is stored, streamed, and presented by the tools, servers, and clients of various multimedia vendors. ASF provides benefits such as local and network playback, extensible media types, component download, scalable media types, prioritization of streams, multiple language support, environment independence, rich inter-stream relationships, and expandability. Further details about ASF are available from Microsoft Corporation of Redmond, Wash.

Encoders 26 can transmit any type of presentation over the network. This includes the information that is used by the encoder/server 14. Examples of such presentations include audio/video presentations (e.g., television broadcasts or presentations from a “NetShow™” server (available from Microsoft Corp. of Redmond, Wash.)), video-only presentations, audio-only presentations, graphical or animated presentations, etc.

Registration interface 20 is configured, in this example, to enable collection of both viewer information and live information from one or more sources. The collected viewer information is stored in database 18 in a viewer information database portion 28 that can be designated for holding only viewer information. The live information is collected and can be stored in database 18 in a live content portion 30. The live content portion 30 holds all of the information that might be associated with a particular electronic presentation or program.

Analysis/Search engine 22 performs all of the analysis and searching that is necessary to enable appropriate notifications to be generated and sent to a viewer. For example, as live information arrives from one or more of the sources 16, the database 18 is updated and a search is conducted to identify all of the viewers, if any, who have registered for notifications. If a particular viewer is found to have registered for a notification when live information of a particular type is detected, then an appropriate notification is generated and sent to the viewer or client viewing device that requested the notification. Examples of various types of notifications are given above.

Exemplary Client Information Database

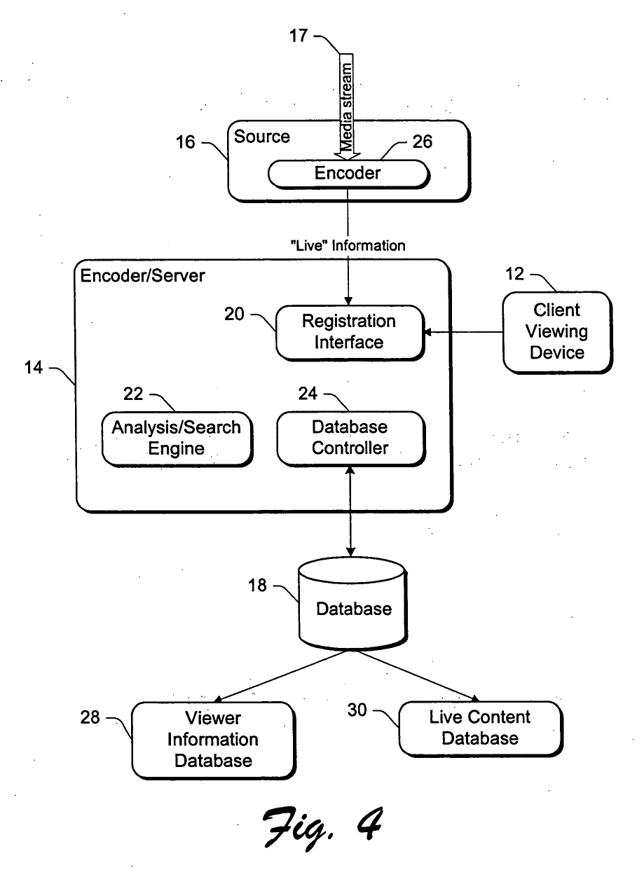

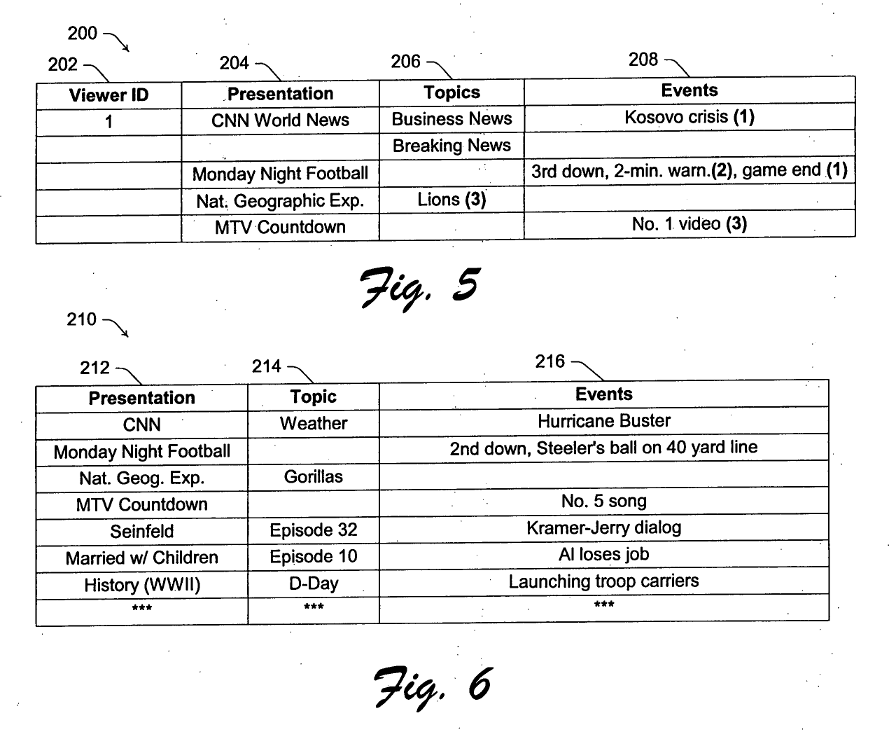

FIG. 5 illustrates entries in an exemplary viewer information database, such as database 28 (FIG. 4) generally at 200. In the illustrated example, four fields are provided, i.e. a viewer ID field 202, a presentation field 204, a topics field 206, and an events field 208. It is to be understood that this constitutes but one example of possible entries in a viewer information database. Other entries are, of course, possible.

The viewer information database enables a viewer to register for notifications for different electronic presentations or programs that might be broadcast by one or more sources, and/or notifications about particular events that might occur within one or more electronic presentations.

The viewer ID field 202 holds the identification of each client viewing device or viewer. The identification is used when a notification is to be sent to a viewer. In this example, only one viewer has registered for notifications.

The presentation field 204 holds the title or name of the electronic presentation or program that has been indicated by a viewer to be of interest. In this example, the viewer has indicated that four programs are being, or, are about to be broadcast that are of particular interest: CNN World News, Monday Night Football, National Geographic Explorer, and MTV Countdown.

The topics field 206 holds any topics that might be of particular interest to a viewer. The topics field gives a viewer the flexibility the register for notifications for certain topics within a particular electronic presentation. In the present example, the viewer has indicated that the topics of “business news” and “breaking news” are of interest with respect to CNN World News. In addition, the viewer has indicated that the topic of “lions” is of interest with respect to the National Geographic Explorer program. In addition, the viewer has assigned a priority rating to the “lions” topic. The priority ratings enable notifications to be generated in accordance with a defined protocol, an example of which is given below.

The events field 208 holds information or events that have been specified by a viewer as being of interest to the viewer. By entering specific information in the events field, a viewer will be notified when the specified events occur within the specified electronic presentation. For example, the viewer has specified that the “Kosovo crisis” is an event of interest with respect to CNN World News. In addition, the viewer has given this specification a priority of “(1)”. With respect to Monday Night Football, the viewer has specified the following events: 3^{rd} down, 2-minute warning, and game end. Priorities have additionally been assigned to the latter two events. Lastly, the viewer has indicated that the No. 1 video is of interest with respect to the MTV Countdown. In addition, a priority of “(3)” has been assigned to the event.

Thus, the viewer has established or defined viewer preferences that will be used to monitor and evaluate various concurrently-broadcast presentations or programs. When a viewer is watching one particular program, they will be notified when a particular topic or event occurs in another program. Notification can take place by automatically switching over to a different program, or by those other methods mentioned above. With respect to the viewer-defined priorities, such might affect the notifications in the following way. Say that a viewer is watching the MTV Countdown and the No. 1 video (priority (3)) is playing. At the same time, the Kosovo crisis (priority (1)) event is detected on CNN World News. Because this event has a higher priority than MTV Countdown's No. 1 video, the viewer might be automatically switched to CNN World News. If, on the other hand, the viewer is watching the Kosovo crisis (priority (1)) on CNN World News, and a 2-minute warning (priority (2)) is detected on Monday Night Football, because the detected event has a lower priority than the currently-viewed event, a viewer might be notified by a visual indication (e.g. icon) rather than by automatically switching the viewer over to Monday Night Football.

As another example of how priorities can affect notifications consider the following: A viewer has registered for the programs as set forth in FIG. 5. If more than one registered event occurs at the same time, then it may be very difficult to switch the viewer to both programs. However, if the viewer has established a priority as between the events, then the event with the highest priority might be automatically switched on for the viewer. Alternately, the event with the highest priority might be fully displayed for the viewer, while the event with the lower priority might only be displayed in a PIP display. Further yet, the event with the highest priority might be displayed in a PIP display without switching the viewer from their current show, while the event with the lower priority might be the subject of an icon notification.

Exemplary Live Content Database

To facilitate searching and notification of viewers, a live content database is established and maintained. Aspects of the live content database can be maintained by the encoder/server 14 of FIG. 1, or by separate encoders as shown in FIG. 2.

FIG. 6 illustrates entries in an exemplary live content database, such as database 30 (FIG. 4) generally at 210. The live content database 210 maintains current, up-to-the-minute information on electronic presentations that are about to be or are being broadcast by various sources. The live content information that is managed in this database can come from, or be associated with many sources that are monitored by the server 14. In the illustrated example, three fields are provided, i.e. a presentation field 212, a topic field 214, and an events field 216. It is to be understood that this constitutes but one example of possible entries in a live content database. Other entries are, of course, possible.

The presentation field 212 includes the name or title of the current electronic presentation or program that is being broadcast by a source. In the illustrated example, there are a number of different presentations or programs that are being monitored. As these programs are being broadcast, information is regularly received by the server 14 or encoder. This information can describe what is taking place during the broadcast. This information is used to continuously update the database so that viewer notifications can be sent in a timely manner.

The topic field 214 identifies the various topics that are currently being presented for the various programs. These topics can, but need not necessarily change during a particular program. In the illustrated example, weather is currently being presented on CNN. Similarly, gorillas are currently being discussed on National Geographic Explorer.

The events field 216 identifies the current events that are being presented on the various programs. For example, the Hurricane Buster is the current event within the weather topic on CNN. Similarly, on Monday Night Football, it is currently 2^{nd} down and the Steelers have the ball on their 40 yard line.

The data or information in the topic field 214 and the events field 216 can be generated manually or automatically. Manual generation refers to an individual (e.g., a presentation author) creating the data. For example, the author may write a summary or a list of key words for the presentation and provide them to server 14 (either directly or via an encoder 26).

Automatic generation refers to one of the components, such as an encoder 26 or server 14, using any of a variety of mechanisms to generate data describing the presentation as the presentation occurs. For example, a conventional key word generation process may be employed to identify key words from the presentation. This may be carried out by an encoder 26, server 14, or some other component coupled to the network. By way of another example, closed captioning information may be used as the data, or a conventional speech-to-text conversion process may be used to convert audio data into text data.

The information maintained in the live content database 30 is used by analysis/search engine 22 (FIG. 4) to evaluate and search the viewer information maintained in the viewer information database. A viewer provides, as part of his or her viewer information, a set of criteria or preferences and which fields the criteria or preferences should be applied to. The viewer can provide such criteria or preferences via any of a wide variety of conventional input mechanisms, such as a graphical user interface (GUI), an example of which is discussed below.

Analysis/search engine 22 compares the viewer-provided criteria to each entry (entries 212-216) in the database 30, or vice versa, to determine whether the electronic presentation corresponding to the entry satisfies the viewer criteria or preference. Any of a variety of conventional searching algorithms and methodologies can be used. For example, any entry with at least one word matching one of the viewer criteria may satisfy the search request, or, an entry may be required to include every word in the search criteria in order to satisfy the search request, etc.

When an event is found that satisfies a viewer's preference, notification takes place as described above.

User Interfaces

One aspect of the invention concerns a set of user interfaces that enable viewers on the client viewing devices 12 (FIG. 1) to register for notifications pertaining to one or more of the presentations or programs.

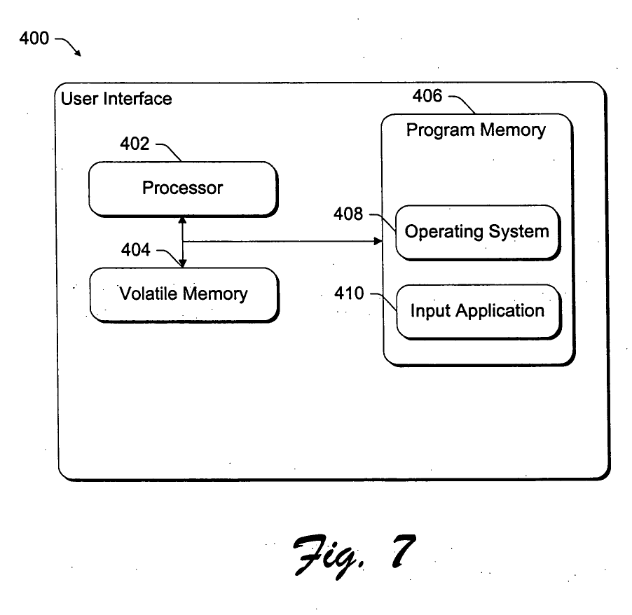

FIG. 7 shows an exemplary user interface unit generally at 400. In this example, user interface unit 400 comprises part of a client viewing device 12. The illustrated interface unit 400 includes a processor 402, volatile memory 404, and program memory 406. The client viewing device runs an operating system 408 which supports multiple applications. The operating system 408 is stored in memory and executes on the processor 402. The operating system can advantageously be a multitasking operating system which allows simultaneous execution of multiple applications. The operating system 408 employs a graphical user interface windowing environment which presents the applications or documents in specially delineated areas of a display screen called “windows.” One exemplary operating system is a Windows® brand operating system sold by Microsoft Corporation, such as Windows® 95 or Windows® NT or other derivative versions of Windows®. However, other operating systems which provide windowing environments can be employed, such as the Macintosh operating system from Apple Computer, Inc. and the OS/2 operating system from IBM.

Registration Interface

An input application 410 is stored in the program memory 406 and executes on the processor 402 to render a viewer display or registration interface that enables a viewer to input information of interest that can be used by the encoder/server 14 to build and maintain its viewer information database 28. This information is used by the server or encoder to conduct the appropriate searches when it receives information in the form of the event notifications described above in connection with FIGS. 1 and 2.

FIG. 8 shows an exemplary registration interface 414 that can be rendered by input application 410 and displayed on a client viewing device 12. The interface 414 includes a title field 415 that includes the titles of the presentations or programs that are currently being or are about to be broadcast. The interface 414 also includes different selection fields that enable a viewer to select one or more electronic presentations and to define specific preferences that will be used for monitoring. In the illustrated example, the selection fields include a default topics/events field 416 and a viewer-defined topics/events field 418. Other fields are, of course, possible.

These selection fields allow a viewer to enter information that pertains to electronic presentations in which they might be interested. The information is then used to monitor the presentation or program that is selected by the viewer. In the illustrated example, a viewer would select a particular presentation by clicking in the box just to the right of the presentation's title. Here, the viewer has selected CNN as a presentation of interest. Once the presentation is selected, a viewer can opt to select either the default topics/events field 416 or the viewer-defined topics/events field 418.

Default Topics/Events Field

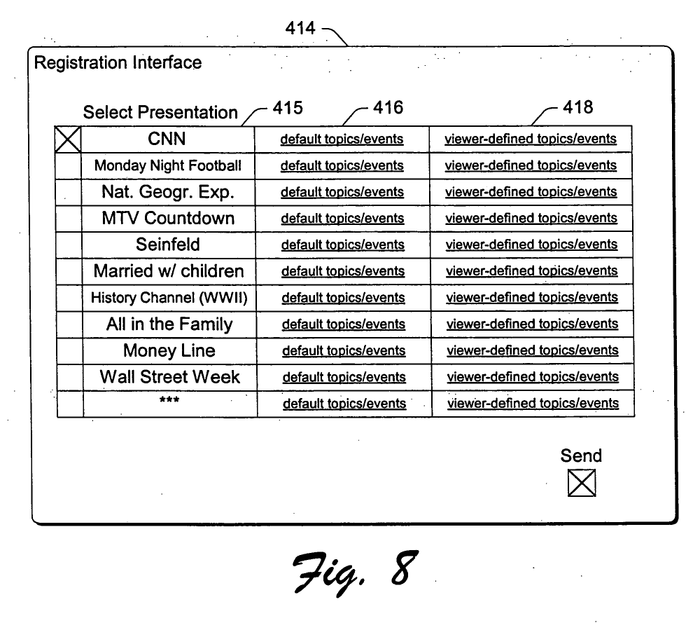

FIG. 9 shows an exemplary interface 420 that can be presented to the viewer when the default topics/events field 416 is selected by a viewer. The interface 420 includes an event menu 422 that lists predefined events that might be of particular interest to a viewer. In the present example, and for the CNN presentation, the viewer can select from between “Recap Top Stories”, “Sports”, “Weather”, “Breaking News”, “Business” and “Community Interest” events. A viewer selects a particular event by clicking on the box just to the left of the event title. In this example, the viewer has selected “Breaking News” and “Business”. The viewer can also assign a priority to the selected events by clicking on the “Priority” box for the selected event and entering an appropriate priority. After the viewer is finished selecting their choices, they can click the “Done” box which packages up the viewer's preferences. When all of the viewer's preferences have been packaged up, the viewer can send their preferences to the server 14 by clicking on the “Send” button (FIG. 8). Any suitable protocol can be used to send the viewer's choices to the server. For example, the viewer's preferences can be bundled up as an XML data packet that is sent to and processed by the server 14. The server can then go about the process of entering the information into the viewer information database (FIG. 4).

Viewer-Defined Topics/Events

In the event that a viewer desires to be more selective in their choices, or in the event that a particular preference is not given as a predefined event in the default topics/events interface 420, a viewer can select the viewer-defined topics/events field 418 from the registration interface 414 (FIG. 8).

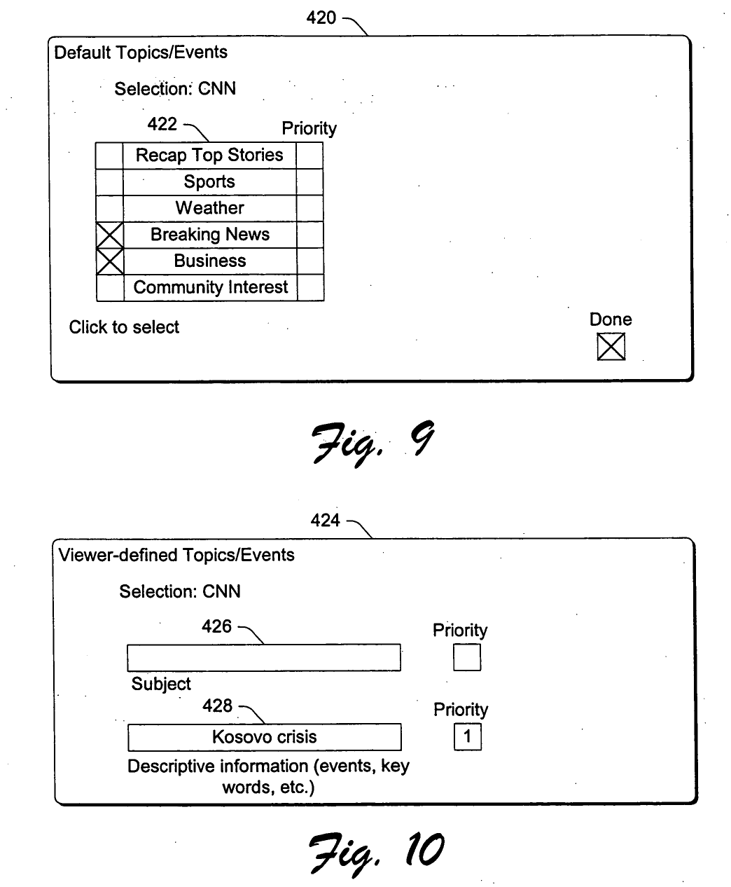

FIG. 10 shows an exemplary interface 424 that can be presented to the viewer when the viewer-defined topics/events field 418 is selected by a viewer. This interface allows a viewer to more narrowly-define their preferences. In the illustrated example, a subject field 426 and a descriptive information field 428 are provided. The subject field 426 enables a viewer to enter a particular subject that may be of interest. The descriptive information field 428 allows the viewer to enter descriptive information that may be of particular interest to the viewer. Each of the fields includes a priority box that can be used to assign a priority to the subject or descriptive information. In the illustrated example, the viewer has, for the CNN presentation, entered “Kosovo crisis” into the descriptive information field 428 and assigned it a priority of “1”. When the viewer has entered all of their preferences for all of their selected programs, the information is sent to the server as mentioned above. Once the information for a particular viewer is in place, monitoring and notification can take place as described above.

In Operation

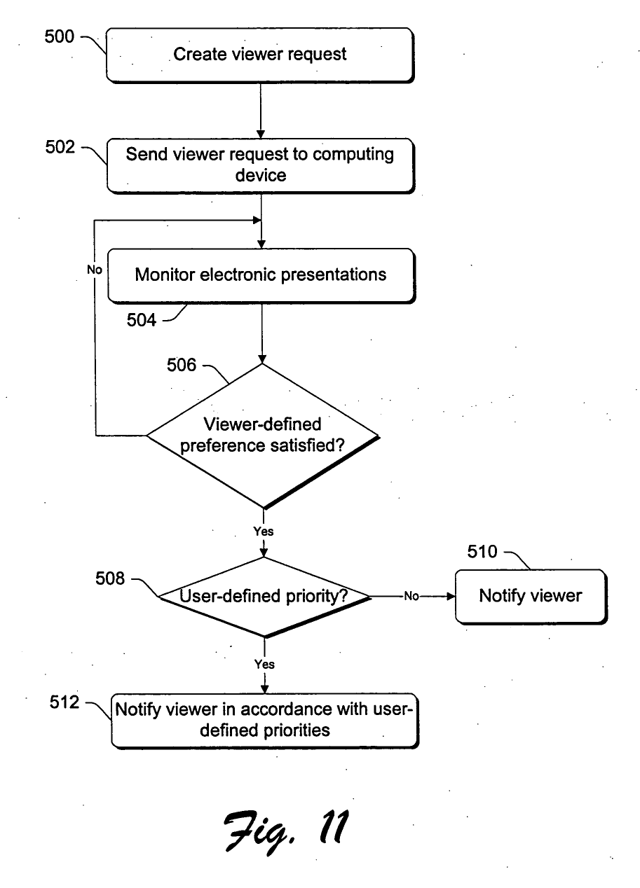

FIG. 11 shows a flow diagram that describes steps in a method in accordance with one embodiment of the invention. Step 500 creates a viewer request. The viewer request contains one or more viewer-defined preferences for use in evaluating one or more live electronic presentations. In the illustrated example, the viewer requests are created using the client viewing device 12 or by some other computing device that is able to convey the viewer's preferences to the server 14. Novel user interfaces are provided to enable the viewer to set their particular preferences. Once the viewer preferences have been established, step 502 sends the viewer request to one or more computing devices. In the illustrated example, the computing devices include an encoder/server 14 (FIG. 1) or a server 14 and a separate encoders (FIG. 2). Other computing devices can be utilized.

When the viewer requests are received, the computing device(s) uses the information that is contained in the request to establish database entries for each of the viewers such as those discussed above in connection with FIG. 5. The database entries maintain lists of viewers and their preferences.

Step 504 monitors a plurality of electronic presentations. In the illustrated example, various live electronic presentations or programs are monitored through the use of information that describes various events or topics that can occur within the presentations. This information is developed in real time as the presentation is being broadcast. The information can be developed manually or automatically as discussed above. As the information is received, e.g. by an encoder (FIG. 2) or by encoder/server 14 (FIG. 1), it is evaluated to determine whether any of the viewer-defined preferences are satisfied. Evaluation of the information can include, without limitation, database searches of the various viewer information that has been collected. If one or more viewer preferences are satisfied, then step 508 determines whether there are any viewer-defined priorities that govern how notification is to take place. If there are no viewer-defined priorities, then step 510 notifies the affected viewers. Notification can take place in any of the ways mentioned above. If step 506 determines that none of a viewer's preferences are satisfied, then the method loops back to step 504 and continues to monitor the electronic presentations. During this time, updated information can be received that pertains to one or more of the electronic presentations. If, at step 508, there is one or more viewer-defined priorities, then step 512 notifies the viewer(s) in accordance with their viewer-defined priorities. Examples of this are given above.

Monitoring Viewing Habits

In one embodiment, viewers need not physically enter their preferences into the system for monitoring. Rather, the viewing habits of one or more viewers are monitored and notifications are sent in accordance with established patterns of viewing.

FIG. 12 shows a flow diagram that describes steps in a method in accordance with this embodiment. Step 600 monitors the viewing habits of one or more viewers. Monitoring can take place in any suitable way. For example, each client viewing device 12 (FIGS. 1 and 2) can have an application that logs the time that a viewer spends on any particular channel and the program that is playing. This information can be packaged up and sent to server 14. Step 602 then establishes a correlation between the viewing time and specific events that transpire during the viewing time. Processing to establish the correlation can take place on the client or server end. The correlations that are established can then be used to establish a viewer-information database similar to the one discussed above in connection with FIG. 5. Once a viewer-information database is established, step 604 monitors the electronic presentations or programs. Monitoring can take place as described above. Step 606 determines whether any of the events that might be of particular interest to a viewer have occurred. If none have occurred, then the method branches back to step 604. If, on the other hand, one or more events have occurred, then step 608 notifies the viewer accordingly. Again, notification can take place in any of the ways discussed above. Step 610 is an updating step that updates the correlation between the viewing time and the specific events that a viewer watches. This step can occur at any time and in parallel with the steps discussed above.

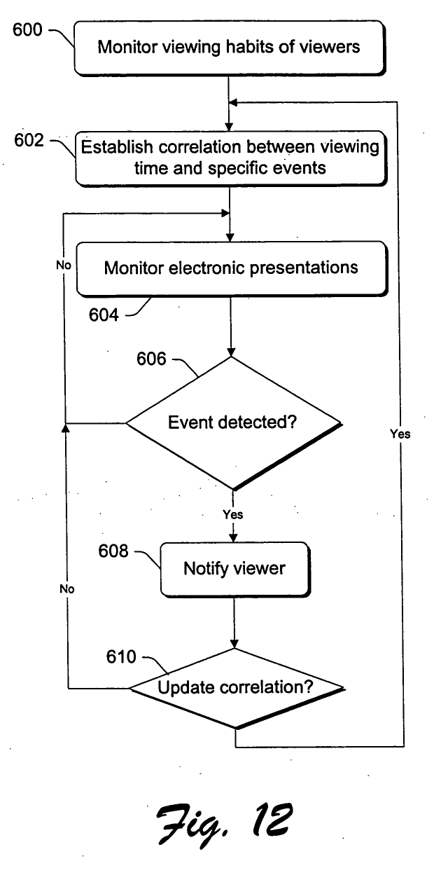

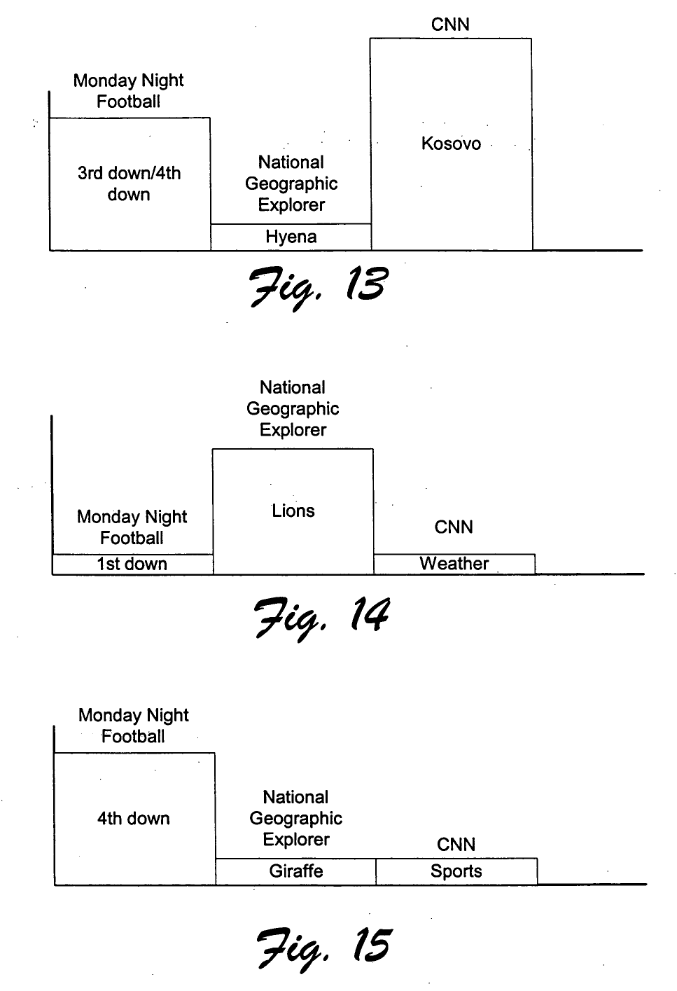

As an example, consider the following: A viewer's viewing habits can be observed over a plurality of time frames during which the viewer is viewing multiple programs. Three such exemplary time frames are shown in FIGS. 13, 14, and 15. During these time frames, the viewer's viewing habits are evaluated to determine whether there is a correlation between the time a viewer spends on a particular channel and the events that are taking place during the viewer's time there. So, for the time frame that corresponds to FIG. 13, it is seen that the viewer spent the most time viewing CNN and, in particular the Kosovo crisis event. The next largest amount of time was spent viewing Monday Night Football and, in particular, third and fourth downs. The least amount of time for the time frame was spent on the National Geographic Explorer channel where hyenas were the topic. With respect to the time frame that corresponds to FIG. 14, it is seen that the viewer spent the most time watching the National Geographic Explorer channel where lions were the topic of interest. Finally, for the time frame that corresponds to FIG. 15, it is seen that the viewer spent the most time watching Monday Night Football where fourth down was the event.

Collectively, the information that is collected during this specific evaluation of the viewer's viewing habits might lead to the following conclusion. Of the programs watched by this particular viewer, the events within each program that appear to be of particular interest are CNN's Kosovo crisis, National Geographic Explorer's lions, and Monday Night Football's fourth and possibly third downs. Given this information, a viewing pattern has emerged for this particular viewer in which the viewing time can be correlated with specific events (step 602). Given this correlation, the various programs can be monitored (step 604), and when events are detected that a viewer is not viewing but would likely want to view, appropriate notifications can be sent.

Conclusion

The viewing management methods and systems described above provide a flexible, adaptable approach to viewing multiple live electronic presentations. In one embodiment, viewers can define their viewing preferences for many different programs. As a viewer watches one program, a number of different other programs are monitored, and, when an event is detected that satisfies a viewer's preference in another of the programs, the viewer is notified in any number of ways. For example, their client viewing device can simply be switched to the other program automatically or, a PIP display can be enabled that displays the program in which the event of interest has occurred. Flexibility is achieved through the use of user interfaces that provide the viewer with an opportunity to select from among a variety of predefined events that might occur in a particular program, or to define their own events, topics, etc. In another embodiment, the viewer's viewing habits are monitored to determine whether the viewer has a particular viewing pattern. Once a pattern is established (i.e. which programs and events are preferred by the viewer), automatic notifications can be sent to the viewer when an event of interest is detected in a program that is not being viewed by the viewer.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. One or more computer-readable media having computer-readable instructions thereon which, when executed by at least computer, cause the computer to implement a method comprising:
simultaneously monitoring two or more electronic presentations that are concurrently broadcast, wherein said monitoring comprises monitoring data that does not comprise content that can be presented to a viewer; and
automatically switching between displays of the two or more electronic presentations based upon viewer-defined preferences, wherein the viewer-defined preferences are defined in terms of priorities that can be assigned to the two or more electronic presentations.

2. The one or more computer-readable media of claim 1, wherein the viewer-defined preferences are defined in terms of specific electronic presentation titles.

3. The one or more computer-readable media of claim 1, wherein the viewer-defined preferences are defined in terms of topics that can occur within electronic presentations.

4. The one or more computer-readable media of claim 1, wherein the viewer-defined preferences are defined in terms of events that can occur within electronic presentations.

5. The one or more computer-readable media of claim 1, wherein the viewer defined preferences are defined in terms of at least one of:
specific electronic presentation titles;
topics that can occur within electronic presentations; and
events that can occur within electronic presentations.

6. The one or more computer-readable media of claim 1, wherein the viewer-defined preferences can be defined in terms of priorities that can be assigned to events that can occur within the two or more electronic presentations.

7. The one or more computer-readable media of claim 1, wherein said automatically switching comprises enabling a picture-in-picture (PIP) display for the viewer in which at least two of the electronic presentations are contemporaneously displayed for the viewer.

8. One or more computer-readable media having computer-readable instructions thereon which, when executed by at least computer, cause the computer to implement a method comprising:
simultaneously monitoring two or more electronic presentations that are concurrently broadcast, wherein said monitoring comprises monitoring data that does not comprise content that can be presented to a viewer; and
automatically notifying a viewer when one or more of the electronic presentations satisfies a viewer-defined preference, wherein said automatically notifying comprises enabling a picture-in-picture (PIP) display for the viewer in which at least two of the electronic presentations are contemporaneously displayed for the viewer.

9. The one or more computer-readable media of claim 8, wherein the viewer-defined preferences are defined in terms of specific electronic presentation titles.

10. The one or more computer-readable media of claim 8, wherein the viewer-defined preferences are defined in terms of topics that can occur within electronic presentations.

11. The one or more computer-readable media of claim 8, wherein the viewer-defined preferences are defined in terms of events that can occur within electronic presentations.

12. The one or more computer-readable media of claim 8, wherein the viewer-defined preferences are defined in terms of at least one of:
specific electronic presentation titles;
topics that can occur within electronic presentations; and
events that can occur within electronic presentations.

13. The one or more computer-readable media of claim 8, wherein the viewer-defined preferences are defined in terms of priorities that can be assigned to the two or more electronic presentations.

14. The one or more computer-readable media of claim 8, wherein the viewer-defined preferences are defined in terms of priorities that can be assigned to events that can occur within the two or more electronic presentations.

15. One or more computer-readable media having computer-readable instructions thereon which, when executed by at least computer, cause the computer to implement a method comprising:
receiving one or more viewer requests from one or more viewers, the viewer requests containing viewer-defined preferences that are to be used to evaluate a plurality of different live electronic presentations;
evaluating a plurality of live electronic presentations using the viewer-defined preferences, wherein said evaluating comprises at least monitoring data that does not comprise content that can be presented to a viewer; and
in the event that one or more of the viewer-defined preferences is satisfied, notifying at least one viewer that is associated with the viewer-defined preference that is satisfied, wherein said notifying comprises displaying indicia of the electronic presentation that is associated with the viewer-defined preference that is satisfied.

16. The one or more computer-readable media of claim 15, wherein said notifying comprises automatically displaying the electronic presentation that is associated with the viewer-defined preference that is satisfied.

17. The one or more computer-readable media of claim 15, wherein said notifying comprises enabling a picture-in-picture (PIP) display for a viewer in which at least two electronic presentations are contemporaneously displayed for the viewer, one of the electronic presentations comprising one which is associated with the viewer-defined preference that is satisfied.

18. The one or more computer-readable media of claim 15, wherein said receiving is performed by a server that is programmed to receive the viewer requests and notify the viewers.

19. The one or more computer-readable media of claim 15, wherein said evaluating comprises:
receiving information describing the electronic presentations as they are being broadcast;
receiving updated information describing the electronic presentations as they are being broadcast; and
evaluating all of the information that is received in light of the viewer-defined preferences.

20. One or more computer-readable media having computer-readable instructions thereon which, when executed by at least computer, cause the computer to implement a method comprising:
monitoring viewing habits of one or more viewers of live electronic presentations to determine particular events within the electronic presentations that the viewers are likely to want to view;
ascertaining from data that does not comprise content that can be presented to a viewer, whether said one or more viewers would likely want to view a particular event; and
based upon monitored viewing habits, notifying one or more viewers when it appears that an event is occurring within an electronic presentation that the viewer is not viewing but would likely want to view wherein said notifying comprises automatically displaying indicia of the electronic presentation, but not the electronic presentation for a viewer.

21. The one or more computer-readable media of claim 20, wherein said monitoring comprises establishing a correlation between the time that a viewer views a particular electronic presentation and the events that transpire during that time.

22. The one or more computer-readable media of claim 21, wherein said establishing comprises evaluating viewer habits over a plurality of time frames during which the viewer is viewing one or more electronic presentations.
